(19) United States
(12) Patent Application Publication
(10) Pub. No.: US 2025/0078312 A1
(43) Pub. Date: Mar. 6, 2025

(54) SYSTEM AND METHOD FOR DEPTH DETERMINATION

(71) Applicant: Compound Eye, Inc., Redwood City, CA (US)

(72) Inventors: Jason Devitt, Redwood City, CA (US); Jorge Cañizales, Redwood City, CA (US); Zachary Flom, Redwood City, CA (US)

(73) Assignee: Compound Eye, Inc., Redwood City, CA (US)

(21) Appl. No.: 18/825,553

(22) Filed: Sep. 5, 2024

Related U.S. Application Data
(60) Provisional application No. 63/536,665, filed on Sep. 5, 2023.

(51) Int. Cl. G06T 7/73; G06T 5/80; G06T 7/55

(52) U.S. Cl. CPC G06T 7/73; G06T 5/80; G06T 7/55; G06T 2207/30244; G06T 2207/30261

(57) ABSTRACT

In variants, the method can include: receiving a first and second image, determining system motion data, determining a set of correspondences based on the first and second image, determining a pixel capture time for each matched pixel, determining an adjusted sensor pose based on the pixel capture time and the motion data, determining a set of depth measurements, optionally performing odometry, optionally creating a depth map, optionally operating a vehicle, and/or other processes. The method can function to determine depth measurements using a rolling shutter camera.

### CROSS-REFERENCE TO RELATED APPLICATIONS

This application claims the benefit of U.S. Provisional Application No. 63/536,665 filed 5 Sep. 2023, which is incorporated in its entirety by this reference.

### STATEMENT OF GOVERNMENT SUPPORT

This invention was made with government support under Award Number W5170123C0020 awarded by the United States Army. The government has certain rights in the invention.

### TECHNICAL FIELD

This invention relates generally to the image processing field, and more specifically to a new and useful method in the image processing field.

### BRIEF DESCRIPTION OF THE FIGURES

FIG. 1 is a schematic representation of a variant of the method.

FIG. 2 is a schematic representation of an example of image capture and un-distortion.

FIG. 3 is a schematic representation of an example of determining a pixel capture delay map.

FIG. 4 is an illustrative example of a stereo camera system with different corresponding pixel capture times.

FIG. 5 is a schematic representation of an example of determining corresponding pixel capture delay and determining adjusted image sensor poses at the corresponding pixel capture times.

FIG. 6 is a schematic representation of an example of determining a 3D location estimate for each matched feature.

FIG. 7 is an illustrative example of correcting measurements sampled by a camera for structure from motion.

FIG. 8 is an illustrative example of a variant for determining a second image sensor's pose.

FIG. 9 is a schematic of an illustrative example of generating a global shutter-equivalent depth map.

FIG. 10 is an illustrative example of a variant of a vehicle with the system attached.

FIG. 11 is an illustrative example of a variant of an image and a corresponding depth map.

FIG. 12 is an illustrative example of a variant of a correspondence being identified off of a horizontal constraint.

### DETAILED DESCRIPTION

The following description of the embodiments of the invention is not intended to limit the invention to these embodiments, but rather to enable any person skilled in the art to make and use this invention.

### 1. Overview

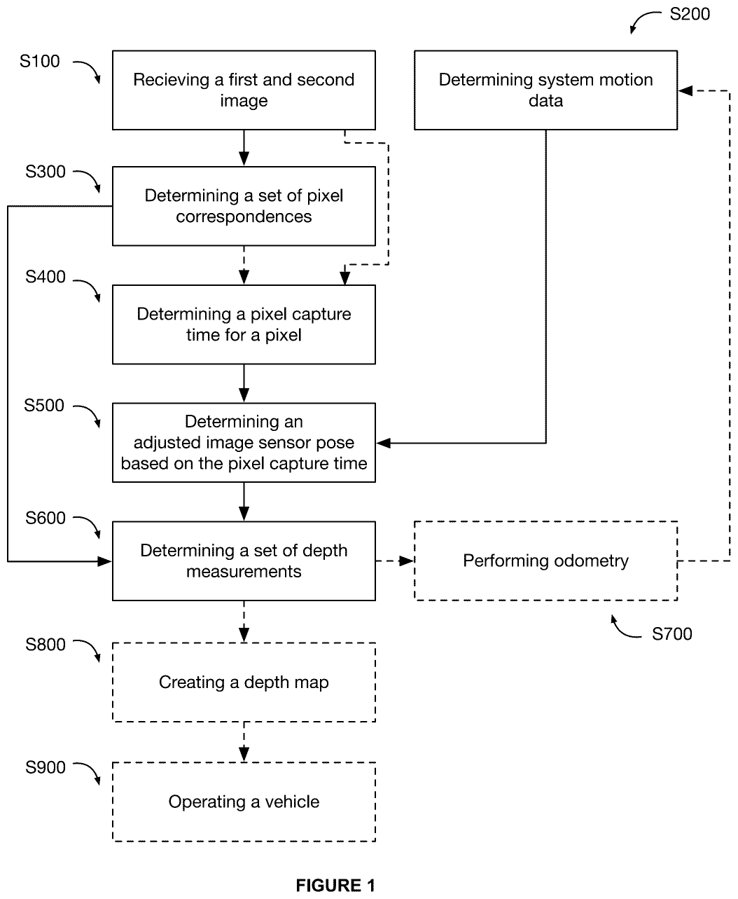

In variants, as shown in FIG. 1, the method can include: receiving a first and second image S100, determining system motion data S200, determining a set of correspondences based on the first and second image S300, determining a pixel capture time for each matched pixel S400, determining an adjusted sensor pose based on the pixel capture time and the motion data S500, determining a set of depth measurements S600, optionally performing odometry S700, optionally creating a depth map S800, optionally operating a vehicle, and/or other processes. The method functions to determine depth measurements using a rolling shutter camera.

In an illustrative example, the method can include: receiving a first image 30 and second image 30 of a scene sampled by a rolling shutter imaging system (e.g., one or more electronic rolling shutter (ERS) cameras), wherein each image 30 is sampled over a sampling duration; un-distorting (e.g., removing lens distortion from) the first and second images; determining the rolling shutter camera motion during the sampling duration for each of the first and second images; determining a set of correspondences between the un-distorted first and second images, wherein each correspondence includes a matching pixel in the first and second un-distorted images that depict the same scene feature; determining a pixel capture delay (e.g., relative to the start, end of image capture, a reference pixel within the rolling shutter image, etc.) for each matched pixel, using a pixel capture delay map 20 for the respective rolling shutter camera (e.g., wherein the pixel capture delay map 20 is determined by distorting the time offset of each pixel using the un-distortion model for the respective rolling shutter camera); determining a pixel capture time for each matched pixel based on the respective pixel capture delay; determining an adjusted pose of the respective rolling shutter camera at each pixel capture time based on the image sensor motion; and determining a depth measurement for the feature based on the adjusted poses and the pixel correspondences. In variants, the first and second images can be sampled by the cameras of a stereo camera pair, or be sampled by the same rolling shutter camera (e.g., for optical flow). In variants, the rolling shutter camera motion can be determined using a previous iteration of the method (e.g., using odometry, egomotion, dead reckoning, etc.), from a motion sensor 200 (e.g., an on-camera IMU), and/or otherwise determined.

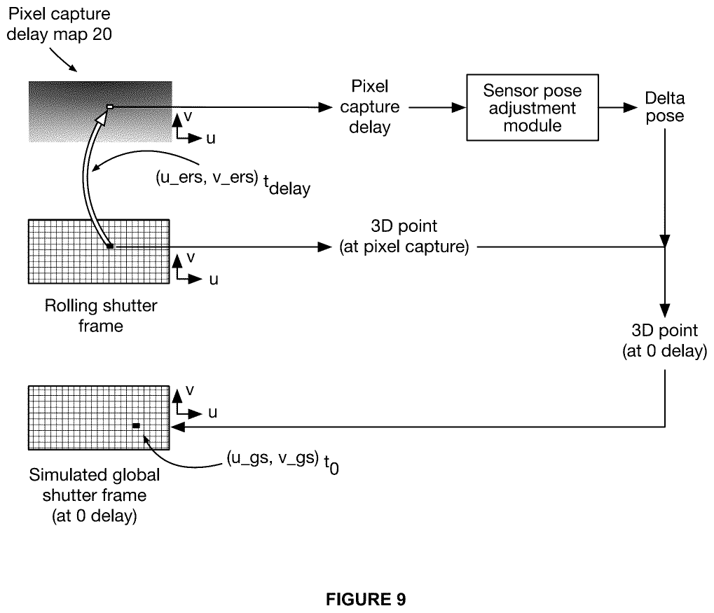

In variants, the depth measurements determined for the rolling shutter pixel correspondences can be reconstructed into a unified depth representation simulating a global shutter version of the data (e.g., example shown in FIG. 9). This method can include, for each matched pixel: determining the image sensor's change in pose (delta pose) between the pixel capture time and 0 delay (e.g., the end of the image capture); un-projecting the pixel to its 3D point (e.g., at the time of pixel capture) and transforming the pixel's 3D point by the image sensor's change in pose to obtain the pixel's 3D point at 0 delay; determining the global shutter equivalent pixel coordinate for the matched pixel by projecting the transformed 3D point back into a virtual camera frame to determine a global shutter pixel position corresponding to transformed 3D point; and assigning the determined depth measurement for the matched pixel to the global shutter equivalent pixel coordinate. However, the method can be otherwise performed.

### 2. Technical Advantages

Variants of the technology can confer one or more advantages over conventional technologies.

First, the technology enables use of rolling shutter (RS) cameras, such as electronic rolling shutter (ERS) cameras for depth estimation. Rolling shutter cameras can confer numerous benefits over global shutter (GS) cameras. For example, rolling shutter cameras offer higher resolution at a given frame rate (e.g., because data is easier to move off the camera); enable a higher frame rate at a given resolution; have a higher dynamic range; have a lower read noise; and/or have better low-light performance than global shutter cameras (GS cameras). These differences can enable rolling shutter cameras to have greater distance range, higher accuracy at a given range, and/or other improved capabilities over global shutter cameras. Additionally, rolling shutter cameras process a lower baseline amount of data over time (as opposed to all at once, as is the case with global shutter cameras). However, the total time to capture an image 30 is longer, and during that capture time the camera can move. This intermediate motion during image capture can lead to motion artifacts and rolling shutter image distortion that complicate downstream tasks like depth measurement. For instance, incorrect estimates of camera pose at the time of capturing a feature can lead to errors in depth determined for the feature. Lens distortions additionally complicate depth measurement for stereo rolling shutter cameras because although horizontal scan lines may be captured simultaneously, they do not correspond to epipolar lines.

In variants, the method can enable depth measurement using rolling shutter cameras by determining the pixel capture time (e.g., relative to the beginning or end of image capture) for matched pixels across a set of images, and accounting for the motion of the image sensor 100 during image capture by determining the camera pose at the time of pixel capture (e.g., determining an adjusted image sensor pose based on the pixel capture time and the image sensor observations). The depth measurement can then be determined based on the pixel coordinates and the adjusted image sensor poses.

Second, variants of the method can generate depth maps calculated using rolling shutter imaging systems with improved accuracy over conventional methods (e.g., the resultant depth map is closer to ground truth, etc.). For instance, variants of the method can enable use of rolling shutter cameras for determining depth maps when moving at high speeds (e.g., in the case of drones, autonomous vehicles, etc.) and/or when estimating the depth to a moving observed feature (e.g., a high-speed vehicle visible to a rolling shutter camera). For example, the use of lens distortion-corrected images to find correspondences, can result in higher-quality correspondences between images, enabling the resulting depth map to be more accurate than a depth map calculated using correspondences determined from images that are not corrected for lens distortion. A higher-quality depth map can enable more accurate downstream analyses (e.g., velocity estimation) and/or can otherwise be beneficial. Additionally or alternatively, the correction of rolling shutter distortions can enable the depth map to be used alongside images and/or depth maps captured from cameras with different exposure patterns (e.g., different rolling shutter patterns, a global shutter camera and a rolling shutter camera, a depth camera, etc.) to be used together in computer vision tasks which ingest both depth and images (e.g., segmentation, depth map generation or augmentation, etc.).

Third, in some variants of the technology, using a two-dimensional delay map specific to an exposure pattern of a camera, the delay map can enable determination of different delays across a row in addition to across multiple rows, which can make the resultant calculated pixel delay more precise. Additionally, the usage of a delay map can enables pose correction for cameras with an irregular exposure pattern (e.g., block-wise capture, spiral, rotational scanning, raster, boustrophedonic, etc.). The delay map can be attuned to a specific camera (e.g., corrected for camera intrinsics particularly, but not exclusively, lens distortion), which enables the delay map to be determined from a raw pixel capture delay map 10 using the same distortion correction model used to correct images captured by the camera. This relationship can enable the pixel capture delay map 20 to be redetermined when camera intrinsics are re-calculated.

Fourth, variants of the method can leverage one or more computationally efficient processes to result in faster depth map determination (e.g., determination of depth maps in real or near real time, during each image capture, etc.). First, the usage of a predetermined map can enable delay to be looked up as opposed to calculated per-pixel. Second, the assumption of constant twist (translational and rotational velocity) can enable pose for each pixel to be calculated by interpolation of a twist. Third, calculated values (e.g., twist, pose) can be shared across different pixels within an image, eliminating redundant calculations. Fourth, calculated values can be shared across cameras. In an example, when a first image sensor twist and/or first image sensor position is known and a second image sensor position relative to the first image sensor is known such as from an extrinsic calibration, the position of the second image sensor can be calculated. The computational efficiency of the method can enable the method to be performed at the edge (e.g., using a processing system 300 integrated with the sensor, using a processing system 300 onboard the vehicle, etc.). The computational efficiency of the method can also enable pose correction before a subsequent image 30 is captured. For variants in which visual odometry (VO) or visual-inertial odometry (VIO) is performed to refine calculated pose values, VO and/or VIO can be performed using information from an image 30 to calculate (e.g., estimate, determine, etc.) the pose at the subsequently-captured image, resulting in a more accurate known pose for the subsequently-captured image 30 (and thus often a more accurate depth).

Fifth, variants of the method can enable the correction of rolling shutter distortions due to a moving observed object. For example, optical flow can be applied to a corrected image 30 and/or depth map determined from the method to correct for rolling shutter distortions not originating from motion of the camera (e.g., distortions resulting from motion of an object within the rolling shutter image, object blurring in an image resulting from motion of said object, etc.). Relatedly optical flow can be used to estimate the velocity of moving objects in images captured from a moving rolling shutter camera (where the estimate of the velocities of the object(s) can then be used to correct the depth of the object(s)). As such, some variants of the method can enable the correction of rolling shutter distortions due to both a moving observed object and motion of the image sensor.

However, further advantages can be provided by the system and method disclosed herein.

### 3. System

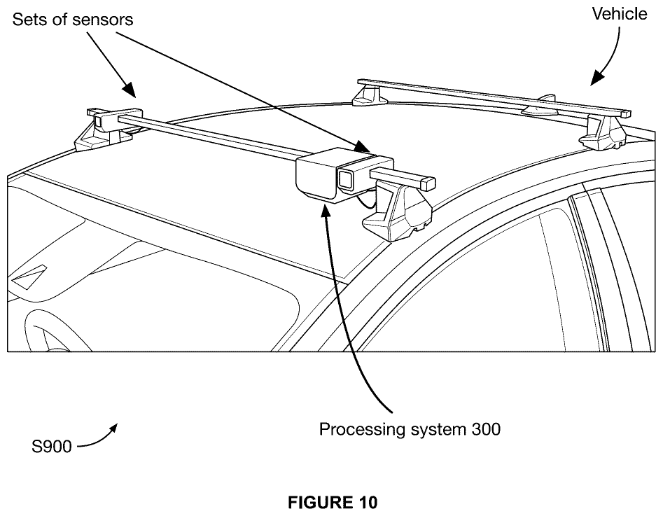

The system for depth measurement functions to facilitate determination of a depth map which corrects for the effect of motion of an image sensor 100 with a rolling shutter exposure pattern. As shown, for example, in FIG. 10, the system can include: a set of image sensors, a motion sensor 200, a processing system 300, and/or other components. In some embodiments, the system can be mounted to a vehicle (e.g., aerial vehicle, terrestrial vehicle, aquatic vehicle, etc.; example shown in FIG. 10), and/or any other suitable ego system.

The set of image sensors function to capture measurements of a scene. The set of measurements are preferably images (e.g., frames), but can additionally or alternatively include depth measurements, kinematic measurements, and/or other measurements. The images can include images generated from pixels captured according to: a row-wise exposure pattern (e.g., one pixel at a time and one row at a time, all pixels in one row at a time, etc.), a column-wise exposure pattern (e.g., one pixel at a time and one column at a time, all pixels in one column at a time, etc.), rotational exposure pattern (e.g., from an exterior pixel to an interior pixel, spiral pattern, from an interior pixel to an exterior pixel, etc.), block-wise exposure pattern, and/or any other suitable pattern (e.g., randomly addressable pixels, pixels addressed according to a space-filling curve, etc.). The image sensor(s) 100 can have a frame rate (e.g., number of frames or images acquired per second (fps), 0 delay times, etc.) of 1000 fps, 480 fps, 240 fps, 120 fps, 60 fps, 30 fps, 24 fps, 12 fps, 10 fps, 5 fps, 1 fps, values, a frame rate within an open or closed range bounded by any of the aforementioned values, and/or any other suitable frame rate. In variants where the set of image sensor 100(s) include more than one image sensor 100, each image sensor 100 preferably has the same frame rate. However, different image sensors 100 can have different frame rates (e.g., as variants of the method can use global timing to correct for, effectively synchronize, etc. the different image sensors 100).

The set of image sensors preferably includes a set of rolling shutter cameras. However, the set of image sensors can additionally or alternatively include any other suitable type of image sensor 100 (e.g., global shutter camera, thermal camera, depth camera, infrared camera, virtual camera, etc.). In one embodiment (e.g., for stereo image analysis), the set of image sensors 100 can include two image sensors 100 (e.g., two rolling shutter camera, a rolling shutter camera and a global shutter camera, etc.). In another embodiment (e.g., for optical flow, structure-from-motion, etc.), the set of image sensors can include one image sensor 100. However, the set of image sensors can include any other suitable number of image sensors 100. The RS cameras are preferably front-facing cameras (e.g., facing the direction of motion of a vehicle to which the camera can be attached). However, the RS cameras can additionally or alternatively include surround-view cameras, back-facing cameras, pan-tilt-zoom (PTZ) cameras, and/or can have any other suitable view. The camera(s) can capture any suitable wavelength (e.g., visible light, IR, UV etc.). In some variants, the set of image sensors can capture depth information directly (e.g. using LiDAR cameras, ToF cameras, structured light cameras, etc.), where the depth information can be fused with the depth information calculated based on the images.

The rolling shutter cameras can be cameras which capture pixels at different times, camera which expose pixels at different times, and/or can be any other suitable type of non-global shutter camera. The rolling shutter effect for a rolling shutter camera can come from mechanical processes, electronic processes, computational processes, and/or any other suitable process. Examples of rolling shutter cameras include progressive scan cameras, staggered shutter cameras, CMOS rolling shutter cameras (e.g., standard, backside-illuminated, stacked CMOS, etc.), DSLR cameras, scientific cameras (e.g., machine vision cameras, scientific imaging cameras, etc.), and/or other suitable RS camera(s). In a first variant, a rolling shutter camera captures pixels one pixel at a time in a row-wise pattern (e.g., where pixels captured at the end of a row are captured at a different time than the pixel at the beginning of the row). In a second variant, a rolling shutter camera captures rows one at a time in a row-wise pattern (e.g., each pixel in a row of the raw image 30 is captured at the same time). In other variants, a rolling shutter camera can have a column-wise, block-wise, spiral, quasi-random, random, and/or any other suitable pixel capture pattern. However, rolling shutter cameras can be otherwise characterized.

In some variants, each image sensor 100 can include (e.g., be coupled to, connected to, attached to, etc.): motion sensors 200 (e.g., accelerometers, gyroscopes, magnetometers, inertial measurement units (IMU), inertial measurement and magnetometry units (IMMU), etc.), location sensors (e.g., GPS, etc.), temperature sensors (e.g., thermocouple, thermometer, etc.), impact sensors, and/or other sensors. However, in some variants, the set of image sensors can include a single sensor (e.g., motion sensor 200, location sensor, thermal sensor, impact sensor, etc.), a single image sensor 100 of the set of image sensors can include a sensor, a sensor can be connected to an external system (e.g., vehicle), and/or a sensor can otherwise be included (and/or excluded). A relationship (e.g., relative pose between, extrinsic calibration) between the sensors and the set of image sensors is preferably known.

Each image sensor 100 can be associated with a set of intrinsic models (e.g., an intrinsic calibration, etc.) and/or extrinsic models (e.g., an extrinsic calibration, fundamental matrix, essential matrix, etc.), determined during image sensor calibration, that are used by the un-distortion model to correct the image. The intrinsic model sets and/or extrinsic model sets are preferably specific to the respective image sensor 100, but can alternatively be shared (e.g., the extrinsic calibration between two or more image sensors 100 can be shared while each image sensor 100 can also include an individual intrinsic calibration or use a shared intrinsic calibration). Intrinsic models can correct for lens distortion (e.g., radial distortion such as correcting barrel distortion, pincushion distortion, mustache distortion, etc.; a tangential or decentering distortion; a thin prism distortion; complex distortions etc.) and/or any other suitable intrinsic distortions (e.g., thermal distortions,). Examples of intrinsic models include the Brown-Conrady model, Mode model, Kannala-Brandt model, polynomial model, division model and/or a unified projection model, pinhole model, fisheye model, orthographic projection model, affinity model, and cylindrical projection model, and/or other suitable model or combination of models. Extrinsic models for an image sensor 100 can model pose (e.g., absolute or relative), orientation, homography, and/or other extrinsic attributes of an image sensor 100 (e.g., between two or more image sensors 100, between an image sensor 100 and an external system or vehicle, between an image sensor 100 and another sensor, between sensors, etc.).

Each image sensor 100 can be associated with a raw pixel capture delay map 10, which describes the raw pixel capture delay in the raw image. In an example, when each row is sampled at the same time, but adjacent rows are sampled sequentially, pixel rows in the raw pixel capture map can be offset by the row sampling delay. The raw pixel capture delay can be relative to a 0 delay time (e.g., the beginning of image capture, the end of image capture, the image sensor motion sampling time, and/or other temporal reference point such as a reference pixel set to the 0 delay time) and/or any other suitable time. The raw pixel capture delay can be retrieved from a datasheet of the image sensor 100 and/or otherwise be determined.

However, the set of image sensors can otherwise be configured.

The motion sensor 200 functions to determine component motion. The data captured by the motion sensor 200 (e.g., motion data) can describe image sensor motion (e.g., camera motion), system motion (e.g., wherein the image sensors 100 and motion sensors 200 are statically mounted to a common system), or other motion. The motion data can include: pose, orientation, rotation, yaw, roll, pitch, vibration, displacement, position, velocity, acceleration, jerk, twist, wrench, screw, and/or can include any other information which describes the system kinematics. In variants where twist is used, twist can include both rotational and translational velocity, where rotation and translation can be along and/or around the same axis or different axes. Preferably, the motion data includes both rotation (e.g., pitch, yaw, and/or roll) and translation (e.g., x, y, and z) but can alternatively include one or neither. Examples of motion sensors 200 that can be used include gyroscopes, inertial measurement units (IMUs), accelerometers, magnetometers, wheel tick odometers, and/or any other suitable motion sensor 200 or inertial sensor. Motion sensors 200 can additionally or alternatively use GPS, dead reckoning systems, visual odometry (e.g., using odometry determined during a prior timestamp using previously-sampled images), visual-inertial odometry (e.g., using the motion sensor 200 measurements and the previously-sampled images), and/or any other suitable type of kinematics determination mechanism to determine and/or refine motion data. In a specific example, motion data (e.g., acceleration and/or velocity) is integrated (e.g., from a prior known position) to calculate a known image sensor pose (e.g., a pose corresponding to current image, previous image, etc.).

The system preferably includes one motion sensor 200 per image sensor 100 but can alternatively include one motion sensor 200 per set of image sensors (e.g., per stereo pair), one motion sensor 200 overall, and/or any other number of motion sensors 200. In a specific example, a pose adjustment for an image sensor (e.g., in S500) is based on an image sensor-specific motion sensor 200. The motion sensors 200 are preferably statically mounted relative to the image sensor 100, but can be otherwise mounted. The motion sensors 200 can be mounted to the image sensor 100 (e.g., the camera), can be inside the image sensor 100 (e.g., within the image sensor housing), can be connected to the image sensor 100 through a mounting system which can be static or dynamic with precisely-calculable pose, or can be located elsewhere.

However, the motion sensors 200 can be otherwise configured.

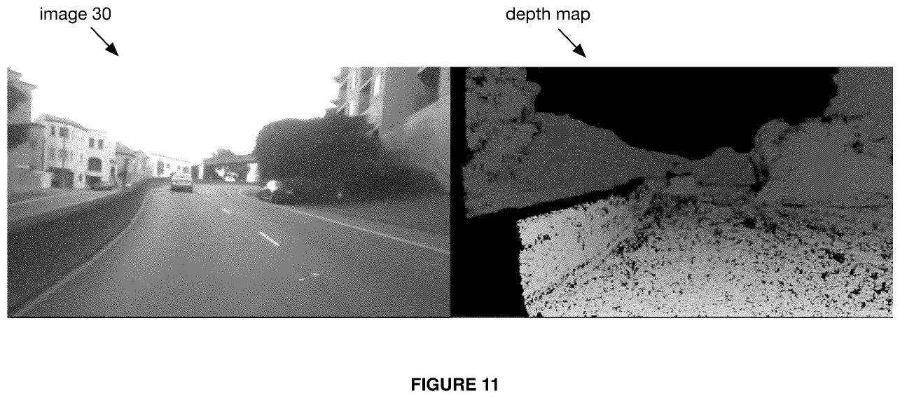

The processing system 300 functions to correct for rolling shutter distortions and lens distortions in images captured by the set of image sensors and generate a depth map (e.g., example shown in FIG. 11). The processing system 300 can perform any or all of S200, S300, S400, S500, S600, S700, S800, and/or S900. The processing system 300 is preferably integrated with the set of image sensors (e.g., a local processor to the vehicle, set of image sensors, etc.) but can alternatively be communicatively connected to the image sensors 100 (e.g., a cloud computing server, distributed compute between a cloud server and a local computing system, etc.). The system can include one processing system 300 for each set of image sensors, one processing system 300 for each image sensor 100, one processing system 300 for each vehicle, and/or any other suitable number of processing systems 300. The processing system 300 can host the un-distortion model, the correspondence determination module, the image sensor pose adjustment module, the depth measurement module, and/or any other suitable system element. In a variant, the processing system 300 can store and/or perform image sensor calibration and/or determine a pixel capture delay map 20 based on the resulting intrinsic parameters.

The pixel capture delay map 20 functions to provides a temporal capture offset for each pixel in an image 30 relative to 0 delay for the image capture (e.g., an effective global shutter image capture time, etc.). A pixel capture delay map 20 (equivalently referred to herein as a “delay map”) is preferably unique to each image sensor 100 (e.g., based on intrinsic parameters of each image sensor 100 determined during calibration, etc.), but can additionally or alternatively be shared between image sensors 100, or be otherwise related between image sensors 100. In a specific example, for a stereo camera, each of the two cameras (e.g., image sensors 100) in the stereo camera are associated with separate and distinct pixel capture delay maps 20.

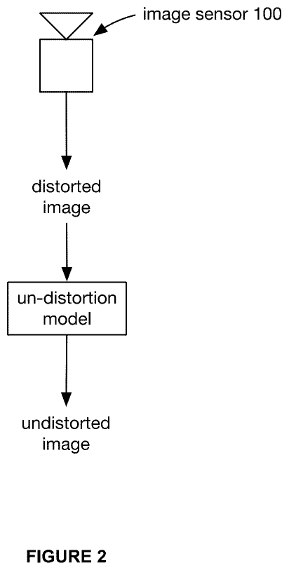

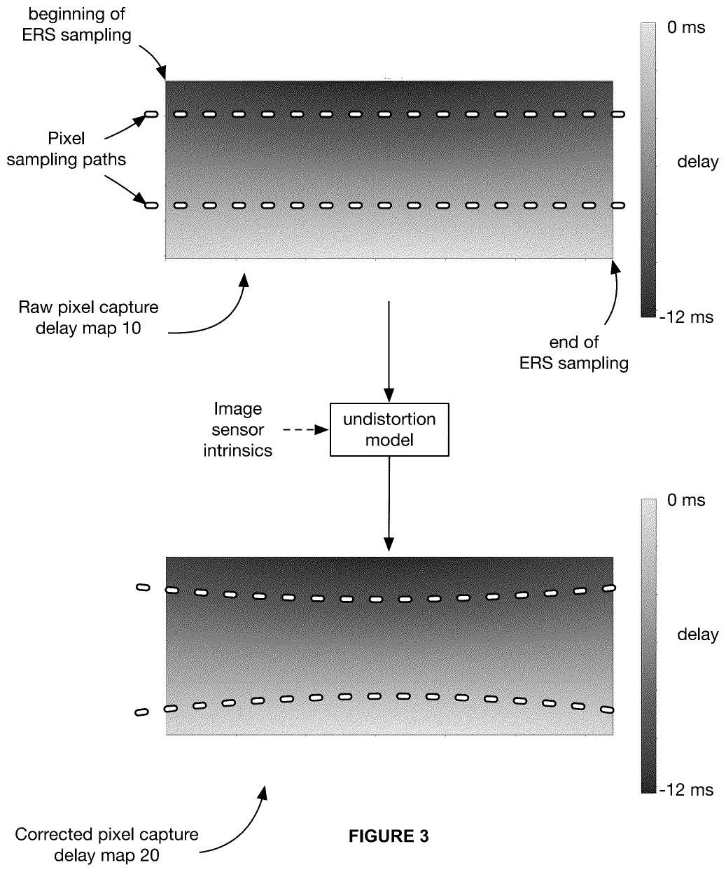

The pixel capture delay map 20 can be determined locally, can be hard-coded into (e.g., stored in) the processing system 300, can be received from a third party, and/or can be otherwise sourced. Preferably, the pixel capture delay map 20 is generated using the un-distortion model (e.g., by applying one or more of the image sensor's intrinsic models to the image sensor's raw pixel capture delay map 10, by directly measuring the delay map, etc.; examples shown in FIG. 2 and FIG. 3) but can alternatively be generated by any other suitable system component.

In a first variant, the pixel capture delay map 20 can be determined by applying an un-distortion model to a raw pixel capture delay map 10. The raw pixel capture delay can model the pixel capture pattern without consideration of lens distortion and/or other image sensor-specific distortions. In this variant, the un-distortion model can apply a set of intrinsic models (and/or extrinsic models) to the raw pixel capture delay map 10 to generate a pixel capture delay map 20 which matches the pixel exposure pattern of an image 30 corrected for lens distortion. In this variant, when the un-distortion model (e.g., intrinsic and/or extrinsic models) are recalibrated (e.g., “on-the-fly”, such as in a manner described in U.S. application Ser. No. 17/154,986, filed 21 Jan. 2021, incorporated herein in its entirety by this reference, etc.), the pixel capture delay map 20 can be redetermined using the new un-distortion model parameters applied to the raw pixel capture delay map 10.

In a second variant, the pixel capture delay map 20 can be determined based on calibration observations (e.g., images and/or video) captured by an image sensor 100 (e.g., in a controlled manner). The calibration observations can be captured while the image sensor 100 is static (e.g., while the vehicle is static) and/or moving (e.g., according to a known or unknown trajectory). The calibration observations can include images captured of a known or unknown pattern. In a first example, the pixel capture delay map 20 can be measured by measuring flashes from a high frequency strobe light (e.g., a set of LEDs arranged in a known pattern), then processing the recordings to create a delay map for the image sensor 100 (e.g., by determining when each pixel recorded a given flash). In a second example, the pixel capture delay map 20 can be determined by moving the image sensor 100 relative to a calibration target, and determining the pixel capture delay map 20 based on when a given calibration target feature is detected in each pixel (e.g., based on a known calibration target pattern and relative motion kinematics).

In a third variant, a machine learning model can be trained to predict the pixel capture delay map 20. In this variant, the model can be trained to predict the pixel capture delay map 20 based on one or more image captured by the image sensor 100, based on video captured by the image sensor 100, and/or optionally kinematic data associated with the image 30 and/or video.

In a fourth variant, the pixel capture delay map 20 can be extracted from the image sensor's datasheet (e.g., the delay map can be independent of image sensor recalibration).

However, the pixel capture delay map 20 can be generated using a combination of the aforementioned methods and/or otherwise generated.

The delay for each pixel can be a positive value, negative value, and/or have any other suitable sign. The delay for each pixel can be relative to a 0 delay time corresponding to an image, and/or delay can be any other suitable reference time. 0 delay can be the beginning of a image capture (e.g., a time the first pixel is captured), the end of a image capture (e.g., a time the last pixel is captured), a time a pixel in a center row is captured, a time an arbitrary reference pixel is captured, and/or any other suitable time. In an example, 0 delay can refer to an effective global shutter time of a rolling shutter camera, which can be a time at which image capture is recorded to have been performed. In another example, 0 delay can refer to an image sensor event of the image sensor 100 corresponding to the pixel capture delay map 20 and/or a different image sensor 100 (e.g., the opposite image sensor 100 in a stereo system, etc.) For instance, delay for a pixel captured by a first image sensor 100 can be calculated relative to an effective global shutter capture time for a second image sensor 100 (e.g., in a stereo system). Additionally or alternatively, delay for a pixel captured by a first image sensor 100 can be calculated relative to an inertial measurement capture time of a motion sensor 200 (e.g., an IMU). However, 0 delay can be any other suitable time. However, the pixel capture delay map 20 can be otherwise configured.

Pixels in a row of a pixel capture delay map 20 typically do not have the same delay (e.g., arising from delays in read between pixels, arising from distortions in the imaging system, as shown for example in FIG. 3, etc.). Accounting for these differences in delay across a row can facilitate use of more generalized rolling shutter systems and/or can enable greater accuracy in the resulting depth map. However, in some variants, pixels in a row of the pixel capture delay map 20 can have the same delay (e.g., can be approximated as having the same delay by tolerating larger error).

However, the processing system 300 can be otherwise configured.

### 4. Method

The method functions to account for rolling shutter distortions (e.g., to improve depth estimation). In variants, the method can include: receiving a first and second image S100, determining system motion data S200, determining a set of pixel correspondences S300, determining a pixel capture time for a pixel S400, determining an adjusted image sensor pose based on the pixel capture time S500, determining a set of depth measurements S600, optionally performing odometry S700, optionally creating a depth map S800, optionally operating a vehicle S900, and/or other processes. In examples, the method can account for lens distortion effects, account for image sensor motion during image capture, account for motion of a feature in a field of view of the image sensor 100, and/or can account for other artifacts. The method (e.g., between S100 and any or all of S500, S600, S700, and/or S800) can be performed in less than 0.5 ms, 1 ms, 2 ms, 3 ms, 5 ms, 10 ms, 20 ms, 30 ms, 40 ms, the frame time (e.g., between successive iterations of S100, etc.), the rolling shutter sampling duration, within any open or closed range bounded by the aforementioned values, and/or any other suitable value or range). In a specific example, S800 is complete before a next iteration of S100 (e.g., a depth can be determined prior to a next image 30 being acquired).

The method can be iteratively performed, periodically performed, performed responsive to occurrence of an event, and/or performed at any other suitable time. The method can be performed in real- or near-real time, asynchronously with image capture, and/or at any other suitable time. All or portions of the method can be performed automatically, manually, semi-automatically, and/or otherwise performed. The method can be performed locally (e.g., at the edge, by an on-board processing system 300, etc.), remotely (e.g., remote from the imaging system), and/or at any other suitable location.

Receiving a first and second image S100 functions to obtain information about a scene. S100 is preferably performed by the processing system 300 but can alternatively be performed by any other suitable system component. The images are preferably received from the set of image sensors but can be received from any other suitable system component. Images can be sampled by the set of image sensors (e.g., rolling shutter sensors). Images are preferably corrected using the un-distortion model (e.g., intrinsic models; example shown in FIG. 2; and/or extrinsic models, etc.) and/or can be uncorrected. In variants where images are corrected, the images can be corrected for lens distortion, focal length, principal point, skew, the pixel aspect ratio, image resolution, and/or any other suitable attribute (e.g., image sensor 100 aberration). In an example, lens distortion coefficients used to correct for lens distortion are (k1, k2, k3, p1, p2), where k1, k2, and k3 refer to radial distortion and p1 and p2 refer to tangential distortion. Images can be uncorrected for extrinsic distortion (e.g., are not rectified images) or corrected for extrinsic distortion (e.g., can be rectified images).

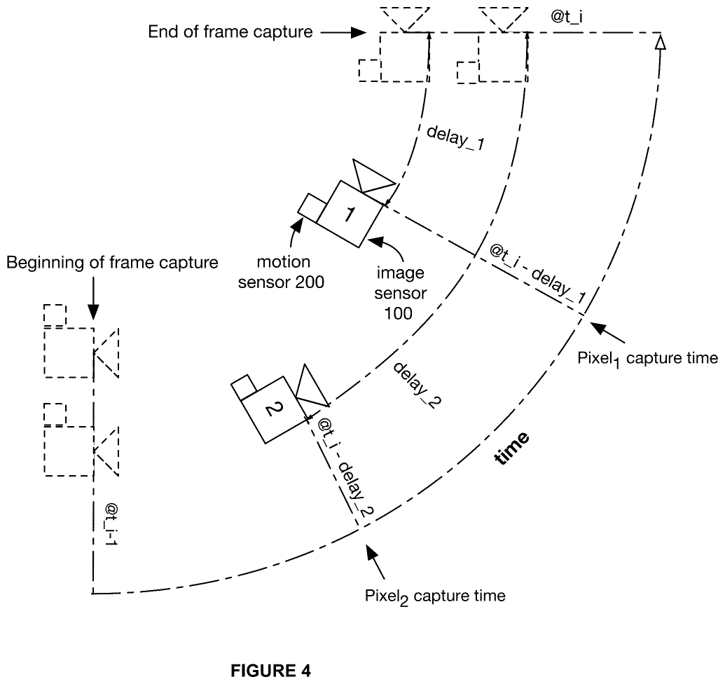

The first and second images preferably depict overlapping views of the scene and/or can have any other relationship. In a first variant, the first and second images are contemporaneously sampled by different image sensors 100 within the image sensor 100 set (e.g., a stereo camera system). In this variant, the image sensors 100 can be synchronized (e.g., example shown in FIG. 4), and image sampling for each image sensor 100 can begin at substantially the same time (e.g., within 0.5 ms, 1 ms, 3 ms, 5 ms, 10 ms, 20 ms, 40 ms, 60 ms, within any open or closed range bounded by any of the aforementioned values, and/or any other suitable value). The rolling shutter windows (e.g., the time span between first and last pixel capture for each image) can overlap or not overlap. The rolling shutter windows can be 0.5 ms, 1 ms, 2 ms, 5 ms, 10 ms, 12 ms, 20 ms, 50 ms, looms, and/or can be any other suitable open or closed range bounded by any of the aforementioned values. Additionally or alternatively, the delay between the first and second image sampling can be known (e.g., predetermined, calculated at capture time, etc.) and accounted for when determining the corresponding pixel capture time (S400) and/or determining the image sensor pose at the pixel sampling time (S500). However, the delay between first and second image sampling can vary (e.g., the image capture can be unsynchronized or poorly synchronized such that jitter is introduced).

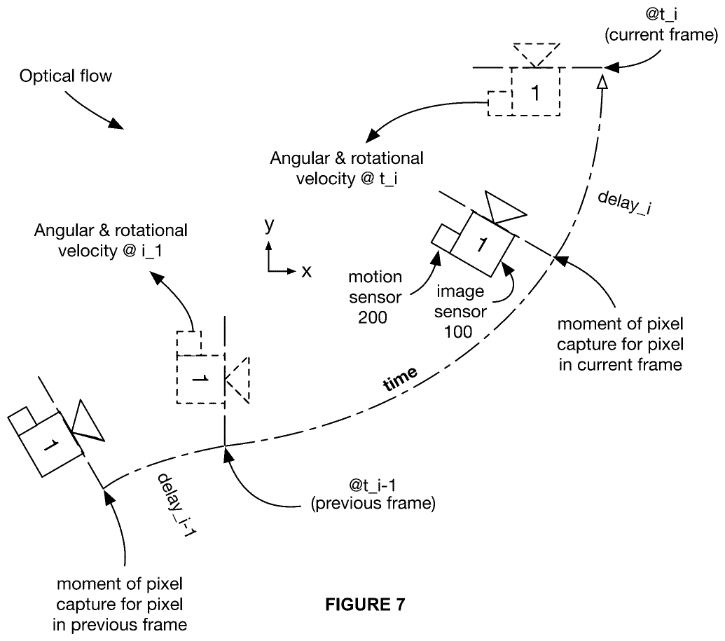

In a second variant, the first and second images can be sampled by the same image sensor 100 at different times (e.g., example shown in FIG. 7). In this variant, the delay between image capture times (e.g., the effective global shutter capture time) and/or pixel capture times can be predetermined, estimated, and/or calculated during image capture. In a first example, the first and second images are sampled in succession (e.g., as consecutive frames). In this example, the delay between image captures can be the frame time plus delays associated with pixels in one or both images (where the delay can be negative or positive depending on which image 30 is used as the reference). In a second example, first and second images are non-consecutively captured. In this example, the delay between image captures can be the time between capture of the first image 30 and second image 30 (e.g., frame time multiplied by the number of image captured between the first and second image) plus delays associated with pixels in one or both images.

Each image 30 can be associated with a 0 delay time (e.g., an effective global shutter capture time, a first pixel capture time, a last pixel capture time, a center line capture time, a motion data capture time, etc.), which can be used as a reference for pixel capture time determination (e.g., S400). The 0 delay time can be associated with a set of image sensor poses and/or kinematics (e.g., position, orientation, angular and/or linear velocity and/or acceleration, etc.), and/or be associated with any other suitable set of data.

However, S100 can be otherwise performed.

Determining system motion data S200 functions to determine system motion during image capture (e.g., to determine reference positions of the image acquisition system at a reference time such as a start of a frame, end of a frame, etc. of image capture). S200 can be performed by a motion sensor 200 (e.g., attached to an image sensor 100; wherein motion data can include IMU data etc.), can be performed by the processing system 300 (e.g., wherein motion data can include data determined through visual odometry, etc.), can be performed by a motion sensor 200 in coordination with the processing system 300 (e.g., wherein motion data can include data determined through visual-inertial odometry, etc.), but can additionally or alternatively be performed by any other suitable system component. In a variant, motion data can be refined by the processing system 300.

S200 is preferably performed for each iteration of S100 (e.g., as frames of a video are captured, etc.), wherein each piece of motion data is associated with an image 30 (e.g., a frame) captured by an image sensor 100, but can alternatively be otherwise performed. The motion data is preferably for a single image sensor 100, but can alternatively be for a set of image sensors (e.g., a stereo camera set), the vehicle, the motion sensors 200, an auxiliary sensor, and/or any other suitable component.

Each piece of motion data is preferably associated with a time window (e.g., describing image sensor motion over the time window). In a first variant, the time window is between the beginning of image capture and the end of image capture (i.e., within a single frame). In a second variant, the time window is between a temporal reference (e.g., 0 delay) of sequential image captures (e.g., between the beginning, end, or middle of sequential image captures, etc.). In a third variant, the time window is a traversal period between a pixel capture time for a first pixel in a first image 30 and a pixel capture time for a second pixel (e.g., a corresponding pixel to the first pixel) in a second image. In the third variant, the motion data differs per-corresponding pixel pair. However, any other suitable time window can be used.

The motion data is preferably contemporaneously and/or concurrently sampled with the first and second image capture, but can alternatively be sampled at a higher frequency, asynchronously, and/or otherwise sampled. In a first variant where motion data is determined asynchronously from the image capture time, motion data for an image sensor 100 is determined for a point after the 0 delay time. In this variant, motion data is optionally interpolated (e.g., using a previous motion data value for the image sensor 100) to determine motion data at a 0 delay time for the image. In a second variant where motion data is determined asynchronously from the image capture time, motion data for an image sensor 100 is determined for a point before the 0 delay time of the image. In this variant, motion data is optionally extrapolated (e.g., using a previous motion data value for the image sensor 100). However, the motion data can be determined with any other suitable temporal relationship with the image.

Motion data can be measured (e.g., sensor data can be directly used), calculated, estimated, and/or can otherwise be determined.

In a first variant, a motion sensor 200 is used to determine motion data. In this variant, the motion sensor 200 can measure linear and/or rotational acceleration, linear and/or rotational velocity, position (or displacement), and/or any other suitable values. In this variant, the measured values can be integrated and/or otherwise processed or not processed to determine motion data.

In a second variant, a visual odometry and/or visual-inertial odometry reading from a prior instance of the method (or via another method, using the same or different set of images) is used to determine motion data. In this variant, the most recent motion data can be ignored or incorporated into the odometrically-determined motion value (e.g., a rolling average). In a first example, a bundle adjustment is performed based on the most recently-captured images. In a second example, the bundle adjustment is performed based on images captured prior to the most recently-captured image. In a specific example, pose is determined by extrapolating pose along an odometrically-determined (e.g., VO, VIO, etc.) twist (e.g., rotational velocity and translational velocity).

In a third variant, a motion sensor 200 determines raw motion data, then motion data is calculated from the raw motion data. In a first example, acceleration is measured and integrated to calculated twist and/or pose. In a second example, pose is measured and used to calculate twist. In examples where twist is determined, pose can be interpolated therefrom using an exponential (e.g., described in Equation 2) and/or other suitable relationship.

However, S200 can be otherwise performed.

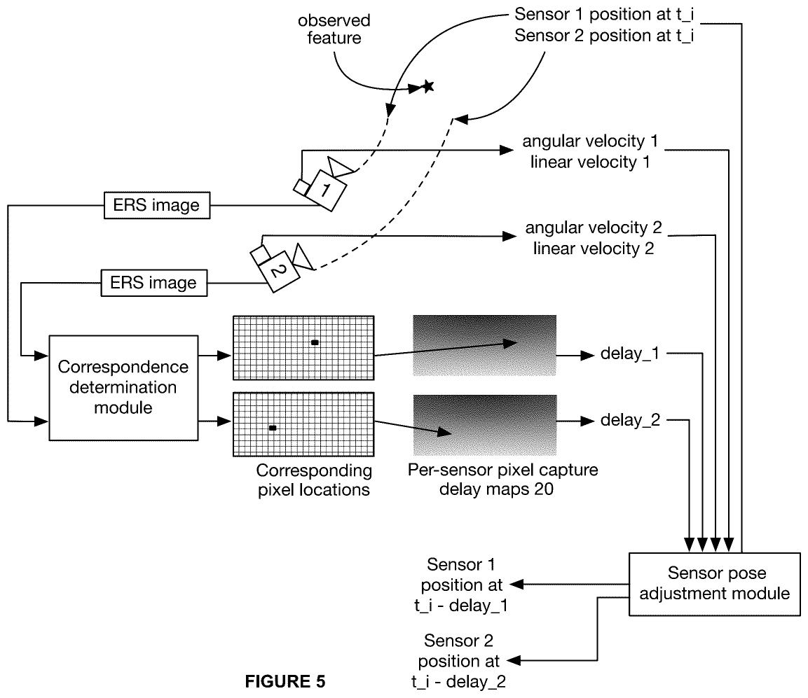

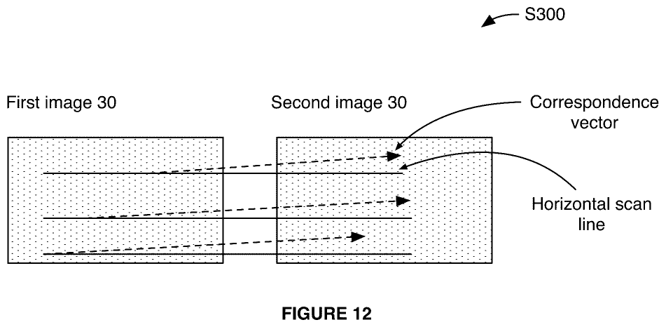

Determining a set of correspondences S300 functions to find matching scene features, more preferably matching pixels, between the first and second images (e.g., example shown in FIG. 5). S300 can be performed after S100 and/or at any other suitable time. S300 is preferably performed after the images are corrected for lens distortion but can additionally or alternatively be performed using images that are not corrected for lens (or other) distrotions (e.g., before the images are corrected for lens distortion). The set of correspondences can be determined in real-time (e.g., immediately after image capture and/or correction, before a next image 30 or set of images are received, etc.), in near-real time (e.g., 0.01 ms after image capture, 0.1 ms after image capture, 0.5 ms after image capture, 1 ms after image capture, 5 ms after image capture, within an open or closed range defined by any of the aforementioned values, and/or within any other suitable time), asynchronously, and/or at any other suitable time. Each correspondence relates matching pixels (corresponding pixels) between the first and second images. Matching pixels can depict the same feature in a scene, or be otherwise matched. The correspondence set can include correspondences for more than a threshold percentage of the pixels in an image 30 (e.g., dense correspondence map); can not include a correspondence for every pixel; or can include correspondences for less than a threshold percentage of the pixels in an image 30 (e.g., sparse correspondence map). Examples of threshold percentages include 40%, 60%, 90%, 95%, 99%, within an open or closed range bounded by any of the aforementioned percentages, and/or any other suitable threshold percentage. Correspondences can be constrained to an epipolar constraint (e.g., a horizontal scan line) and/or not constrained by an epipolar constraint. In an example, correspondences are determined off of an epipolar line (e.g., example shown in FIG. 12).

In a variant, correspondences can additionally match a pixel from a third image 30 with pixels from the first or second image. In this variant, one of the pixels is captured by an image sensor 100 in a stereo camera pair, and the other pixel is captured by the same image sensor 100 in the stereo camera pair at a different (e.g., prior or subsequent) timestep. This variant enables the calculation of optical flow values to correct for motion of observed features after the motion of the set of image sensors is corrected.

Determining a set of correspondences S300 can include using correspondence matching algorithms to identify matching pixel sets between two images. When images are uncorrected, the raw pixel capture delay map 10 can be used instead of the pixel capture delay map 20 to determine the corresponding pixel capture delays; when images are corrected the pixel capture delay map 20 can be used. Correspondences can be determined using: sum of absolute differences (SAD), normalized cross correlation (NCC), semi-global matching (SGM), graph based methods, neural network methods, a method described in U.S. application Ser. No. 15/479,101 filed 4 Apr. 2017, incorporated in its entirety by this reference, a method described in U.S. application Ser. No. 17/104,898 filed 25 Nov. 2020, incorporated in its entirety by this reference, and/or any other suitable stereo matching or correspondence determination method. In an example, an initial correspondence map (e.g., a prior correspondence map, a new correspondence map determined using a Halton sequence, etc.) and a set of candidate correspondence vectors (e.g., including prior correspondence vectors from the initial correspondence map, random correspondence vectors, candidate correspondence vectors for neighboring pixels, average correspondence vectors produced by combining correspondence vectors for two or more neighboring pixels, etc.) can be determined for each pixel of an image. In this example, a resultant correspondence vector can be selected (e.g., by minimizing a cost function, for example string distance, Hamming distance, Levenshtein distance, edit distance, Jaro-Windkler distance, a sum of absolute differences, etc. for comparing a pixel hash with pixel hashes for each of the candidate corresponding pixels from the set of candidate correspondence vectors; calculated by aggregating candidate correspondences, etc.) from the candidate correspondence vectors. The process of evaluating candidate correspondences can be repeated for a predetermined number of iterations, until less than a target number of correspondences changes during an iteration, and/or any suitable number of times and/or target criterion is met.

However, S300 can be otherwise performed.

Determining a pixel capture time for a pixel S400 functions to determine when each matched pixel was actually sampled by the image sensor 100. S400 can be performed before the image 30 is finished being captured, after all the pixels in the image 30 being captured, and/or at any other suitable time. S400 can be performed after S100, during S300 (e.g., only for pixels with correspondences, for all pixels before correspondences are determined, etc.), and/or at any other suitable time. In a variant (e.g., when S30o and S400 are performed at the same time) corresponding pixels identified to have been captured at the same time can be flagged. Flagged pixels can be used as ground-truth values for image sensor extrinsic parameter determination (e.g., the difference in pose between the pixels is not affected by rolling shutter-originating pixel capture delays) and/or other suitable processes.

The pixel capture time can be a relative time (e.g., relative to 0 delay for the image capture), absolute time (e.g., wall clock time), and/or any other suitable time. The pixel capture time is preferably determined using the pixel capture delay map 20 for the image sensor 100 used to capture the respective image 30 (e.g., example shown in FIG. 5), but can additionally or alternatively be determined using a shared pixel capture delay map 20, a high-frequency clock (e.g., tracking the sampling time of each row or pixel), and/or otherwise determined. In a first variant, S400 can include looking up the pixel capture delay for the matched pixel (e.g., using the matched pixel's coordinate) on the pixel capture delay map 20. In a first example, when the correspondences are determined using corrected images (e.g., un-distorted images), the pixel capture delay can be determined using the pixel capture delay map 20 (e.g., the raw pixel capture delay map 10 that has been transformed using the image sensor's un-distortion model). In a second example, when correspondences are determined using uncorrected images (e.g., distorted images), the pixel capture delay can be determined using the raw pixel capture delay map 10 (e.g., untransformed). However, any other suitable pixel capture delay map 20 can be used. In a second variant, the pixel capture delay can be calculated based on an observed pixel capture delay relative to the image capture time of the respective image. In a third variant, a pixel capture delay for a pixel from a first image 30 is subtracted from a pixel capture delay for a corresponding pixel from a second image 30 to determine a relative pixel capture delay. However, pixel capture delay can be otherwise determined.

Pixel capture time can be a function of pixel capture delay, image capture time (e.g., 0 delay time), image capture delay (e.g., delay in image capture relative to an image 30 of the other image sensor 100, delay in image capture relative to an intended image capture time, etc.), motion sensor 200 capture delay, and/or any other suitable time and/or delay values. In a first variant, pixel capture time and pixel capture delay are synonymous. In a second variant, pixel capture time incorporates pixel capture delay (e.g., as determined from the delay map) in addition to other delays (e.g., differences in 0 delay times between stereo cameras, etc.). However, pixel capture time and pixel capture delay can be otherwise related.

However, S400 can be otherwise performed.

Determining an adjusted image sensor pose based on the pixel capture time S500 functions to estimate the pose, position, and/or orientation of the image sensor 100 at the time a pixel was captured (e.g., example shown in FIG. 4). This accounts for system motion between the capture of the first and second matched pixel in a pixel correspondence pair. S500 can be performed for each image, each matched pixel (e.g., in a matched pixel pair), for each matched pixel pair (e.g., correspondence), for multiple matched pixel pairs (e.g., multiple correspondences), for a subset of matched pixels for which a correct depth is desired, and/or for any other suitable set of pixels. S500 can be performed one or more times for each correspondence pair and/or feature. S500 is preferably performed after S400 (e.g., after pixel correspondences and/or pixel capture delays are determined) but can additionally or alternatively be performed at any other suitable time (e.g., while the images are being captured image sensor pose can be determined).

S500 can include: optionally determining a known image sensor pose, determining the motion of the image sensor 100 over a traversal period, and determining the adjusted image sensor pose based on the known image sensor pose and the object motion.

Determining a known image sensor pose functions to determine a baseline pose relative to which a pose change is determined. The known image sensor pose can be: the image sensor pose at 0 delay, the image sensor pose at the time motion data was captured, an effective global shutter pose, the image sensor pose at the beginning of a measurement session (e.g., from initial image sensor 100 power-on), an image sensor pose verified by a pose sensing system (e.g., GPS, etc.), a known pose at the time of a different image sensor's known image sensor pose (e.g., in a stereo system, etc.), and/or any other suitable image sensor pose. The known pose can already be represented in motion data (e.g., wherein the motion values calculated in S200 are used in S500), can be determined from motion data (e.g., interpolated, extrapolated, integrated, differentiated, determined from a bundle adjustment, using methods described in S200, etc.), and/or otherwise determined.

The traversal period is preferably the time period between the time associated with the known image sensor pose and the pixel capture time but can alternatively be the time period between a pixel capture time and a pixel capture time of another image sensor 100, the time period between a pixel capture time and a 0 delay time of another image sensor 100, and/or another time period. The image sensor motion can be determined using: dead reckoning (e.g., using motion sensor 200 measurements), visual odometry and/or visual-inertial odometry (e.g., using values from a prior iteration of S700; where the system trajectory, velocity, rotational velocity, etc. calculated at the prior image capture time(s) is assumed to be constant and is used to extrapolate an image sensor pose), and/or any other suitable method. The image sensor motion can be: the translational kinematics (e.g., velocity, acceleration, etc.), the rotational kinematics (e.g., velocity, acceleration, etc.), and/or other motion. In an example, sensor motion is the twist of the image sensor 100 (e.g., 3D rotational velocity and 3D translational velocity along/about colinear or non-colinear axes) over the traversal period. In this example, twist can be calculated from motion data, can be calculated from known poses, and/or calculated from other suitable values. Twist (and/or one or more component thereof such as linear velocity, rotational velocity, velocity with respect to one or more axis, etc.) can be assumed to be constant over the traversal period (e.g., the time between a first pixel capture time and a second pixel capture time), a linear function over the traversal period, a continuous function over the traversal period, a piecewise function over the traversal period (e.g., in variants where the traversal period spans multiple image captures, as in variants where depth is determined from structure-from-motion methods), and/or can otherwise change or not change over the traversal period. A benefit of the assumption of constant twist is that the twist calculation can be performed once for an image 30 and/or image pair; rather than for each pixel (e.g., due to pixels being captured at different times).

The location of each image sensor 100 at each pixel capture time (e.g., adjusted image sensor pose) can be calculated by extrapolating the image sensor's known pose based on the image sensor's motion during the pixel capture time and the 0 delay time, and/or otherwise determined. Determining an adjusted image sensor pose based on the pixel capture time S500 can additionally or alternatively include interpolating between two known image sensor poses associated with timepoints before and after the pixel capture time, and/or otherwise determining the image sensor pose at the pixel capture time. S500 can include determining image sensor poses independently of each other, determining image sensor 100 non-independently of each other, determining only relative poses of the image sensors 100, determining an image sensor pose path, for and/or otherwise determining image sensor poses.

In a first variant, S500 includes determining each image sensor's pose for a corresponding pixel pair.

In a first embodiment, for each pixel, S500 includes: for each pixel, determining a pose of the respective image sensor 100 which captured the pixel at 0 delay; determining the linear velocity and/or angular velocity of the image sensor 100 at 0 delay (e.g., from odometry, from S200, etc.); and interpolating or extrapolating the image sensor pose from the known pose, using the linear and angular velocity (e.g., twist, where the twist can be assumed to be constant between the 0 delay and the respective pixel's delay), to the respective pixel's delay.

In a second embodiment, S500 includes computing the linear and/or angular velocity between two image captures using the logarithm of an inter-frame delta-pose (ΔP_{previous→current}) of a first and/or second image sensor 100 (e.g., using Equation 1); and calculating the image sensor pose at the first and/or second pixel capture time by adjusting the position of the image sensor 100 at 0 delay (for the current image) with the pose changes over the pixel capture delay, where the pose changes over the pixel capture delay is calculated using the exponential of the linear and/or angular velocity between the 0 delay time and pixel capture time (e.g., using Equation 2). The inter-frame delta-pose can represent the change in pose, position, and/or orientation of the image sensor 100 between the current image capture's 0 delay time and the previous image capture's 0 delay time, between the current image capture's 0 delay time and the pixel capture time, between the previous image capture's 0 delay time and the pixel capture time, between the pixel capture time for a pixel in first image 30 and the pixel capture time for a pixel in the second image, and/or can represent pose change over another suitable time window. The logarithm of the inter-frame delta pose value can represent the average angular and linear velocities of the image sensor 100 over that time window. The pixel capture time can be between the image capture times, can be outside of the image capture times, or can be at any other suitable time.

$${v}_{angular \& linear} = log ( Δ {P}_{p r e v i o u s \to current} ) / ( {t}_{{0}_{c u r r e n t}} - {t}_{{0}_{p r e v i o u s}} ) ∈ {R}^{6} \qquad ( Equation 1 )$$

$${P}_{pixel delay} = exp ( v \cdot {t}_{d e l a y} ) ∈ SE ( 3 ) \qquad ( Equation 2 )$$

However, any other suitable set of equations can be used.

In a second variant, S500 includes determining the first image sensor's pose for a first matched pixel, and determining the second image sensor's pose based on the first image sensor's pose. This variant can be particularly useful when stereo camera systems are used for image capture, since the extrinsics (e.g., relative pose between the image sensors 100) are known and substantially fixed. In this variant, the first image sensor's pose can be determined using the second embodiment of the first variant (e.g., using Equation 1 or Equation 2), and the second image sensor's pose can be determined based on the first image sensor's pose at the second pixel capture time and the second image sensor's pixel capture time, using the known relative pose between the first image sensor 100 and the second image sensor 100. In this variant, the second image sensor's pose is preferably calculated without determining motion data (e.g., twist, 0 delay poses, etc.) for the second image sensor 100 but can alternatively include determining motion data for the second image sensor 100. In a specific example, the pose determined through extrinsics can be compared with a pose determined independently of the other image sensor 100 (e.g., as in the first variant, etc.) and corrected based on the comparison. The first image sensor's pose can be determined using the second embodiment of the first variant; can be interpolated or extrapolated based on sensor motion, the known image sensor pose at a reference time, and the pixel capture time relative to the reference time; and/or can be otherwise determined.

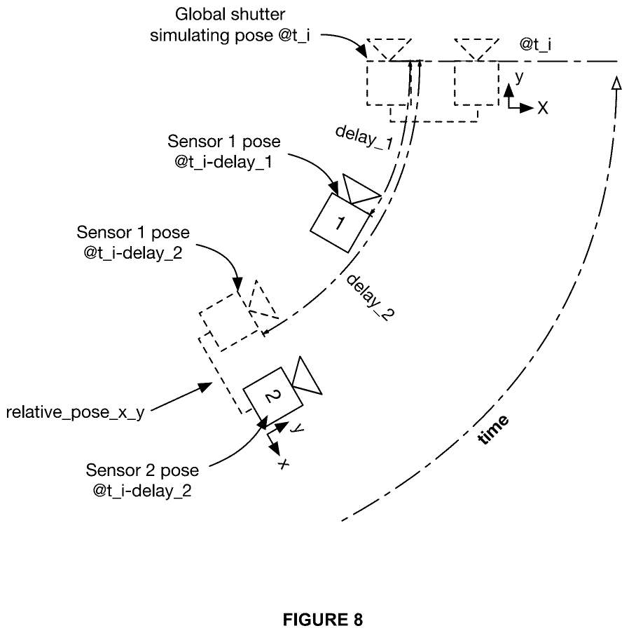

In a first example (e.g., described in Equation 3B), the second variant can include: determining the first image sensor's pose, for the first image sensor's pixel capture time (e.g., t_{L}); determining a first image sensor delta-pose between the first image sensor's pose at the first pixel capture time (t_{L}) and the first image sensor's pose at the second pixel capture time (t_{R}), and determining the second image sensor's pose at the second pixel capture time (t_{R}) based on the extrinsics (e.g., known pose between the first and second image sensors 100), example shown in FIG. 8.

In a second example, this variant can include: determining the first image sensor's pose at the second pixel capture time (t_{R}). In this example, the second embodiment of the first variant can be used to determine the first image sensor's pose, which is converted into the second image sensor's pose (e.g., as described in Equation 3A).

$${P}_{R} = exp ( {v}_{L} \cdot ( {t}_{R} - {t}_{R c urrent} ) ) \cdot Δ {P}_{extrinsics} \qquad ( Equation 3 A )$$

$${P}_{R} = {P}_{L} \cdot exp ( {v}_{L} \cdot ( {t}_{R} - {t}_{L} ) ) \cdot Δ {P}_{extrinsics} \qquad ( Equation 3 B )$$

In a third variant, S500 includes determining the relative pose between the first and second image sensors 100 of a stereo camera at the respective pixel capture times (e.g., t_{L} and t_{R}), where the relative pose (e.g., instead of the absolute poses) can be used to determine the depth measurement (e.g., using triangulation). In embodiments, the relative pose can be determined based on the extrinsics pose between the first image sensor 100 and second image sensor 100, and the delta-pose of one image sensor 100 between t_{R} and t_{L}. The delta-pose of the one image sensor 100 can be determined based only on the time difference between t_{R} and t_{L}, be determined based on other time delays, and/or otherwise determined. In an example, the delta-pose of the first image sensor 100 can be determined using:

$$v = \frac{log ( Δ P )}{Δ t} ∈ {R}^{6} \qquad ( Equation 4 )$$

$$delta pose of first {camera}_{{t}_{R} \to {t}_{L}} = exp ( v \cdot ( {t}_{L} - {t}_{R} ) ) ∈ SE ( 3 ) \qquad ( Equation 5 )$$

where OP is the change in the first image sensor pose from the previous image 30 to the current image, and ⊗t is the time between the previous and current image 30 (e.g., the time between the respective 0 delay times). v can represent the average angular and/or linear velocity over the time between the previous and current image, and can be assumed to be the same for all pixels in the first image sensor 100. An advantage of this variant is that the delta pose only needs to be calculated for one image sensor 100 (however, in variants, the delta pose can be calculated for both image sensors 100). In an example of this variant, the adjusted pose of one or both image sensors 100 is corrected by an expected pose change (e.g., between 0 delay and pixel capture time) during the delay (e.g., a typical pose change given the kinematics of the image sensors 100, determined from prior iterations from the method, hard-coded into the processing system 300, etc.). However, the relative pose can be otherwise determined.

In a fourth variant, S500 can include determining an image sensor pose for a single image sensor 100 in motion. This can be particularly useful for structure from motion, or determining depth from optical flow. For each flow correspondence, a flow depth algorithm can ingest two image sensor poses, previous pose and current pose (e.g., example shown in FIG. 7), which can be determined using similar equations as those used in the first variant or third variant, with a key difference being that multiple pose changes can be measured between the first image 30 and the second image 30 (the first and second images can be sequential or not). Image sensor pose at pixel capture time for each matched pixel can be determined (e.g., using interpolation or extrapolation) based on an assumption that angular and/or linear velocities are constant with a step change between image capture times, but pose can alternatively be determined using other assumptions. In an example, the delta-pose (the change in pose between pixel capture time and 0 delay time) can be determined by applying an exponential to the calculated velocities and pixel capture time (as in Equations 3A and 3B), and poses of image sensors 100 at pixel capture time can be calculated using the pose of the image sensor 100 at 0 delay time and the determined delta-pose. Using the poses of image sensors 100 at each pixel capture time, a difference in pose between an image sensor 100 capturing a first pixel and the image sensor 100 capturing a second pixel can be determined, and depth can be calculated with an optical flow method using the pose difference. Any other suitable method can additionally or alternatively be used to calculate depth. In a variant, the first pose can be calculated by composing together pose changes between the first pixel capture time (e.g., t₁) and the second pixel capture time (e.g., t₂), and/or composing together pose changes between the first pixel capture time (e.g., t₁) and second image capture's 0 delay time. In this variant, the first pixel pose can be determined by any other suitable method.

In variants where both a set of image sensors and an object represented within images captured by the image sensors 100 are moving, optical flow can be used to estimate the motion of the object (e.g., between image capture times, between t_{L} and t_{R}, etc.) and correct the image 30 to account for motion of the object (e.g., by interpolating or extrapolating the position of the object along a velocity vector determined using optical flow, etc.). This correction can enable depth to be calculated as if velocity of the object was 0 between t_{L} and t_{R}. Additionally or alternatively, these variants can determine or set an error bound on the depth in the depth map and/or can otherwise be used.

However, S500 can be otherwise performed.

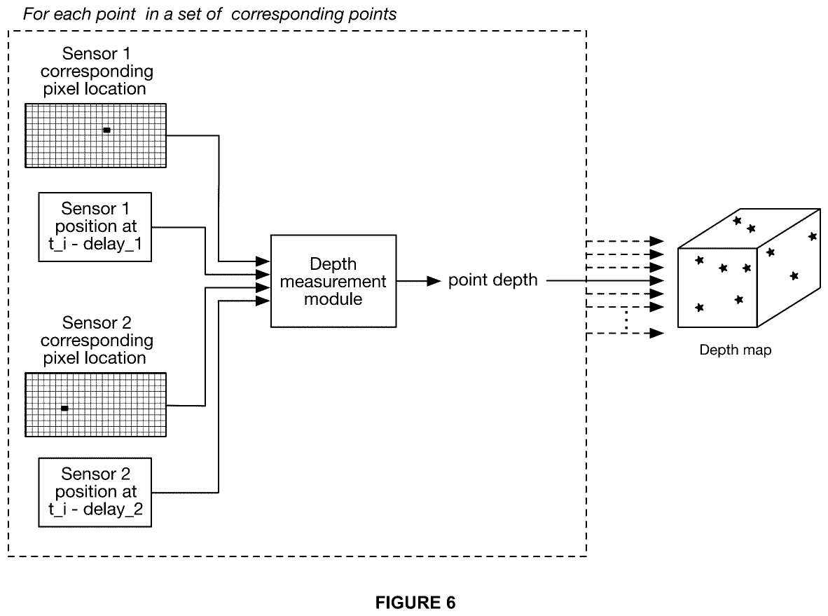

Determining a depth measurement S600 functions to determine depth (e.g., 3D coordinates) for each matched pixel based on the correspondences and optionally respective adjusted image sensor poses (e.g., example shown in FIG. 6). S600 is preferably performed after S500 but can alternatively be performed at any other suitable time (e.g., after corresponding pixels are determined). S600 can be performed before a next iteration of S100, S200, and/or any other suitable process. The depth can be in global coordinates, relative coordinates (e.g., relative to the image sensor 100, relative to a reference point on the image sensor mount, relative to the vehicle, etc.), and/or in any other suitable reference frame. The depth can be associated with: the pixel capture time, the 0 delay for the image capture, an aggregated time calculated from the 0 delays for the image captures (e.g., an average between the 0 delays for the image captures), and/or any other suitable time. The depth measurement can be determined using triangulation or another depth estimation method. The depth measurement can be determined: using an essential matrix, using a direct linear transformation, using a midpoint method, and/or using any other suitable triangulation method. The depth measurement can be determined using a depth measurement module and/or any other suitable component. In other variants, the depth (e.g., for each pixel, feature, etc.) can be determined using the corresponding pixels (e.g., triangulation of the corresponding pixels) and can be corrected based on the image capture time (e.g., based on a correction for the image sensor pose at the time of pixel access such as determined in S500).

However, S600 can be otherwise performed.

Optionally performing odometry S700 functions to estimate the image sensor's pose difference between image captures, using the differences in estimated depth measurements between image captures. S700 is preferably performed after S600 but can alternatively be performed after S800, and/or at any other suitable time. S700 can be executed synchronously or asynchronously with S500, S600, and/or any other suitable steps. S700 can be performed before a next iteration of S100, S200, and/or any other suitable process. In an example, S700 may be performed using indirect odometry (e.g., by minimizing reprojection error of matched features, where the reprojection error is a function of image sensor poses at pixel capture time). For example, given a pixel capture time estimated using the pixel capture delay map 20, S700 can construct differentiable expressions which interpolate between consecutive pose variables (e.g., using constant angular velocity and constant linear velocity and/or any other assumptions), which are used in the odometry solver.

However, S700 can be otherwise performed.

Optionally generating a depth map S800 functions to generate a single-image depth map, without pixel capture delay artifacts, from a set of global-shutter equivalents of the depth measurements (e.g., example of global shutter pose shown in FIG. 8; example of generating a single-image depth map in FIG. 9). The global-shutter equivalent can be associated with (e.g., from the perspective of) the pose of a image sensor 100 at 0 delay time, the pose of an image sensor 100 at the pixel capture time, and/or any other suitable pose. Generating a depth map S800 enables rolling shutter depth measurements to be used in conventional depth analysis pipelines. Generating a depth map S800 can use the depth measurement of each matched pixel (e.g., from S600), image sensor pose, optionally raw images from each image sensor 100 and/or a virtual capture time, and/or any other suitable information. Depth measurements of the scene can be output as a depth map (a global-shutter equivalent) or some other depth representation from the perspective of an image sensor 100 at the image capture pose (e.g., 0 delay pose) or any other point. Depth values can optionally be associated with an error value which can be determined as a function of pixel coordinates (e.g., within the image), object speed, image sensor twist, and/or any other suitable parameters. Additionally or alternatively the depths in rows, columns, and/or pixels of the depth map can be associated with different times (e.g., the respective times of capture for the same pixel coordinate in an image) where each depth can then also be used with the pixel capture delay map 20.

In a first variant, generating a global-shutter equivalent of the depth measurement can include: determining the delta pose for the image sensor 100 between the pixel capture time and the 0 delay (e.g., through interpolation); un-projecting the pixel to the 3D depth coordinate; transforming the 3D depth coordinate by the delta pose to determine the 3D depth coordinate at 0 delay; projecting the 3D point back into the camera frame to determine the shifted pixel coordinate (e.g., global-shutter equivalent of the matched pixel); and assigning the transformed 3D depth coordinate to the shifted pixel coordinate (e.g., example shown in FIG. 9). Additionally or alternatively, the GS-equivalent of the rolling shutter depth measurement can be otherwise determined. Fusion pipelines (e.g., 3D reconstruction pipelines) can use the shifted pixel coordinate and/or the transformed 3D depth coordinate. Additionally or alternatively, the GS-equivalent of the pixel coordinate (e.g., the shifted pixel coordinate) and/or the GS-equivalent of the depth coordinate (e.g., transformed 3D coordinate) can be otherwise used.

In a second variant, generating a global-shutter equivalent of the depth measurement uses a Gauss-Newton estimate (e.g., single-step estimate, multi-step estimate, etc.) to estimate depth without estimating image sensor pose first. In this variant, depth is first estimated from a correspondence between pixels in a first and second image captured by a first image sensor 100 and second image sensor 100, assuming images were captured with no relative delay or image sensor motion (e.g., ignoring image sensor delay or relative motion). The time-delta between the first and second pixel capture times are then determined. For each image sensor 100, the point (e.g., associated with the pixel detected in the respective image) is un-projected (e.g., into 3D space), corrected based on the fraction of the delta pose that represents the vehicle motion during the time-delta (e.g., determined based on the delay between first and second image sensor observations, such as the pose change over the 2 ms between the first and second image sensor observations), and then projecting the point back into that image sensor 100. The change in pixel coordinates between the original observation and the reprojected point is determined and used to correct the original disparity for the respective camera and/or used to recompute the depth. Alternatively, depth can be re-estimated using the reprojected pixels, and a depth map can be determined. This method can be repeated until sequential estimation points match or for greater accuracy.

In a third variant, generating a global-shutter equivalent of the depth measurement can include determining depth for each corresponding pixel's pixel capture time using optical flow. In this variant, S500 can include: determining the optical flow for each matched pixel (e.g., from a previous iteration, etc.); and interpolating or extrapolating a pixel location for each matched pixel along the pixel's optical flow vector based on the respective pixel capture time. In variants, this occurs without losing information describing the pixel match for the pixels. Pixel match data can be stored per-extrapolated matched pixel or can be otherwise retained. This interpolation and/or extrapolation can be done either in pixel space or in 3D space. Depth map can be determined using the interpolated or extrapolated matched pixels.

In a fourth variant, generating a global-shutter equivalent of the depth measurement can include scaling flow vectors. In an embodiment of this variant, flow vectors for matched pixels are adjusted (by interpolation, extrapolation, or other methods) based on the ratio between the difference in pixel capture time between pixels in subsequent image captures and the optical flow frame rate. A ratio between a difference in pixel capture time between pixels in non-subsequent image captures and the difference in image capture times may also be used. For example, if t₁ (first capture time) occurred at 7/8 of the timespan between a tₚᵣₑᵥᵢₒᵤₛ (previous image capture) and t_{current} (current image capture), and t₂ (second capture time) occurred 15/16 of the timespan between the t_{current} and tₙₑₓₜ (next image capture), a flow vector can be scaled by a ratio of 17/16 to compensate for the varying effective image capture rate between pixel captures at t₁ and t₂. Image captures can be subsequent or non-subsequent, and flow vectors can be adjusted accordingly. Flow vectors can be determined by any method and can be alternatively or additionally adjusted by other methods. In a variant, a first or second image 30 in an optical flow method can be modified or synthesized by adjusting the position of a pixel in a matched pixel pair according to the adjusted flow vector for the pixel pair. The adjustment of the position of the pixel can be an interpolation or extrapolation along the direction of the flow vector, but adjustment can be alternatively performed. Depth can be calculated based on the adjusted pixel location, directly from the adjusted flow vector, or otherwise; and a depth map can be generated from the calculated depths.

In a fifth variant, generating a global-shutter depth equivalent of the depth measurement can include: using the flow to adjust the disparity as if the image sensor observations were synced, and then computing the depth from x-disparity.

However, S800 can be otherwise performed.

Optionally operating a vehicle S900 functions to control an autonomous vehicle based on the image sensor observations (e.g., determined in S700), based on a depth map (e.g., determined in S800), and/or depth measurements (e.g., determined in S600). S900 is preferably performed after S800 but can alternatively be performed at any other suitable time. S900 is preferably performed by the processing system 300 but can alternatively be performed by a vehicle control system in communication with the processing system 300. S900 is preferably performed before a next iteration of S100 and/or S800 but can alternatively be performed at any other suitable time. In a first example, the depth map is ingested by a model which is configured to semantically segment an image 30 based on the image 30 and a depth map determined from the image, and the resultant segmented image and/or map can be used by a decision-making control algorithm to control or generate suggested operating instructions for the autonomous vehicle. In a second example, the depth map is used to calculate the trajectory of objects surrounding the vehicle. In a specific example, flow can be determined from successive depth maps to identify which objects in a scene are moving and which direction the objects are traveling in.

However, S900 can be otherwise performed.

In further variants, elements of the aforementioned variants can be combined or repeated any number of times and in any number of ways.

However, the method can be otherwise performed.

All references cited herein are incorporated by reference in their entirety, except to the extent that the incorporated material is inconsistent with the express disclosure herein, in which case the language in this disclosure controls.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

We claim:

1. A depth sensing system configured to determine a 3D position of an object represented in each of a first image and a second image comprising:
a first rolling shutter camera configured to capture the first image; and
a processing system configured to:
determine a correspondence between a first feature from the first image and a second feature from the second image, wherein the first feature and the second feature are associated with the object, wherein the first feature is located at a pixel coordinate in the first image;
determine a first feature capture time for the first feature based on a delay map and the pixel coordinate, wherein the delay map:
comprises pixel capture delays for pixels in images captured by the first rolling shutter camera; and
is corrected for a lens distortion of the first rolling shutter camera;
determine a first feature capture pose for the first rolling shutter camera based on the first feature capture time and a set of motion information; and
calculate the 3D position of the object by performing triangulation on the object based on the first feature and the second feature using the first feature capture pose.

2. The depth sensing system of claim 1, wherein determining the first feature capture time comprises selecting a predetermined pixel capture delay at the pixel coordinate from the delay map.

3. The depth sensing system of claim 1, wherein:
the processing system is further configured to correct the first image for the lens distortion of the first rolling shutter camera; and
the pixel coordinate comprises a coordinate in the corrected first image.

4. The depth sensing system of claim 1, wherein the 3D position of the object is calculated before a subsequent image is captured by the first rolling shutter camera.

5. The depth sensing system of claim 1, wherein the set of motion information comprises a twist of the first rolling shutter camera during a time window between:
an effective global shutter time for the first image; and
a capture time of a previous image captured by the first rolling shutter camera; and
wherein the first feature capture pose is determined from a pose interpolation over the time window using the twist of the first rolling shutter camera.

6. The depth sensing system of claim 5, further comprising a second rolling shutter camera configured to capture the second image; and wherein the processing system is further configured to:
determine a second feature capture time based on the second feature and a second delay map associated with the second rolling shutter camera; and
determine a second feature capture pose based on a pose of the first rolling shutter camera at the second feature capture time and an extrinsic relationship between the first rolling shutter camera and the second rolling shutter camera, wherein the second feature capture pose is used to calculate the 3D position of the object.

7. The depth sensing system of claim 6, wherein the second delay map is distinct from the first delay map.

8. The depth sensing system of claim 6, wherein the second feature capture pose is determined without calculating a twist of the second rolling shutter camera.

9. The depth sensing system of claim 1, wherein determination of the correspondence between the first feature and the second feature comprises evaluating corresponding pixels deviating from an epipolar constraint.

10. The depth sensing system of claim 1, wherein the first rolling shutter camera is mounted on an autonomous vehicle, wherein the 3D position of the object is used to generate operating instructions for the autonomous vehicle.

11. A method configured to determine a 3D position of an object represented in each of a first image and a second image comprising:
receiving the first image acquired using a first rolling shutter camera;
determining a correspondence between a first image feature from the first image and a second image feature from the second image, wherein the first image feature and the second image feature are associated with the object and wherein the first image feature is located at a pixel coordinate in the first image;
extracting a second image feature from a second image, wherein the second image feature corresponds to the first image feature;
determining a first image feature capture time for the first image feature based on the first delay map and the pixel coordinate, wherein the delay map:
comprises pixel capture delays for pixels in images captured by the first rolling shutter camera; and
corrected for a distortion of the first rolling shutter camera;
determining a first image feature capture pose for the first rolling shutter camera based on the first image feature capture time and a set of motion information; and
calculating the 3D position of the object by performing triangulation on the object based on the first image feature and the second image feature using the first image feature capture pose.

12. The method of claim 11, wherein determining the first image feature capture time comprises selecting a predetermined pixel capture delay at the pixel coordinate from the delay map.

13. The method of claim 11, further comprising correcting the first image for the lens distortion of the first rolling shutter camera, wherein the pixel coordinate comprises a coordinate in the corrected first image.

14. The method of claim 11, wherein the 3D position of the object is calculated before a subsequent image is captured by the first rolling shutter camera.

15. The method of claim 11, wherein the set of motion information comprises a twist of the first rolling shutter camera during a time window between:
an effective global shutter time for the first image; and
a capture time of a previous image captured by the first rolling shutter camera; and
wherein the first image feature capture pose is determined from a pose interpolation over the time window using the twist of the first rolling shutter camera.

16. The method of claim 15, wherein the second image is captured by a second rolling shutter camera, and further comprising:
determining a second image feature capture time based on the second image feature and a second delay map associated with the second rolling shutter camera; and
determining a second image feature capture pose based on a pose of the first rolling shutter camera at the second image feature capture time and an extrinsic relationship between the first rolling shutter camera and the second rolling shutter camera, wherein the second image feature capture pose is used to calculate the 3D position of the object.

17. The method of claim 16, wherein the second delay map is distinct from the first delay map.

18. The method of claim 16, wherein the second image feature capture pose is determined without calculating a twist of the second rolling shutter camera.

19. The method of claim 11, wherein determination of the correspondence between the first image feature and the second image feature comprises evaluating corresponding pixels deviating from an epipolar constraint.

20. The method of claim 11, wherein the first rolling shutter camera is mounted on an autonomous vehicle, wherein the 3D position of the object is used to generate operating instructions for the autonomous vehicle.
